(19) United States
(12) Patent Application Publication
(10) Pub. No.: US 2010/0247735 A1
(43) Pub. Date: Sep. 30, 2010

(54) EDIBLE FAT AND OIL COMPOSITIONS

(75) Inventors: Takeshi Kamegai, Kanagawa (JP); Reiko Ejiri, Kanagawa (JP); Tetsuro Iwasawa, Kanagawa (JP); Michio Kasai, Kanagawa (JP)

Correspondence Address: BUCHANAN, INGERSOLL & ROONEY PC, POST OFFICE BOX 1404, ALEXANDRIA, VA, 22313-1404, US

(73) Assignee: THE NISSHIN OILLIO GROUP, LTD., Chuo-ku (JP)

(21) Appl. No.: 12/681,501

(22) PCT Filed: Oct. 3, 2008
(86) PCT No.: PCT/JP2008/068058

§ 371 Date: Apr. 2, 2010

(30) Foreign Application Priority Data
Oct. 3, 2007 (JP) 2007-260057
Feb. 15, 2008 (JP) 2008-034868

(51) Int. Cl. A23D 9/00; A23L 1/01; A23L 1/48

(52) U.S. Cl. 426/607; 426/438; 426/531

(57) ABSTRACT

The present invention discloses an edible fat and oil composition which makes possible to prepare cooked foods having good taste and smell. The present invention also discloses an edible fat and oil composition comprising palm olein having an iodine value of 64 or more and corn oil.

### TECHNICAL FIELD OF THE INVENTION

The present invention relates to edible fat and oil compositions, in particular, edible fat and oil compositions which make possible to prepare cooked foods having good taste and odor.

### BACKGROUND OF THE INVENTION

Edible fats and oils are widely used as a heating medium for use in heat-processing of foods or as a seasoning agent. These fat and oil compositions have a conventionally known problem to be solved that odor is generated by oxidation degradation.

Oxidation degradation is further promoted when fat and oil compositions are exposed to light or high temperature. Such a problem is recognized as an important problem to be solved, particularly when considering storage stability of edible fats and oils.

Various considerations have been made in order to solve this problem. In the following patent literature, the odor in bright light that is generated by photooxidation of an edible fat and oil in a container is suppressed by adding an ultraviolet absorbing agent to the container of an edible fat and oil.

Patent Literature 1: JP-A 7-322819

### DISCLOSURE OF THE INVENTION

However, it was difficult to add an ultraviolet absorbing agent to all kinds of containers of an edible fat and oil made of different materials and form them as a container. Further, it had not been considered at all that cooked foods having good taste and smell can be prepared using a fat and oil composition before being exposed to a degradation environment.

In view that edible fats and oils are often used for production of cooked foods such as fries, it has been desired to develop edible oil which make possible to prepare cooked foods having good taste and smell, not only after the oil is exposed to the degradation environment but also before the oil is exposed to the degradation environment.

The inventors thoroughly searched to solve the problem and found that cooked foods having good taste and smell can be prepared by using a fat and oil composition comprising a specific palm olein and corn oil. The present invention has been completed based on this finding.

Accordingly, the present invention provides an edible fat and oil composition comprising palm olein having an iodine value of 64 or more and corn oil.

The present invention also provides an edible fat and oil composition which comprises palm olein having an iodine value of 64 or more and corn oil at a mass ratio of 10:90-80:20, wherein the total amount of the palm olein and the corn oil in the whole edible fat and oil composition is 50-100 mass %.

The present invention further provides an edible fat and oil composition comprising palm olein and corn oil, wherein said edible fat and oil composition is filled in a container having a volume of 2 L or less, at least a part of which is formed of a light transmissive material.

The present invention further provides a method for producing a cooked food which comprises cooking food materials using either one of the above edible fat and oil compositions.

The present invention further provides a food which is produced by using either one of the above edible fat and oil compositions.

### BEST MODE FOR CARRYING OUT THE INVENTION

The edible fat and oil composition of the present invention can be obtained by combining palm olein and corn oil and, optionally other components. Each component and their formulated amounts. etc. are further illustrated below.

### Palm Olein

In the present invention, “palm olein” indicates an edible liquid oil, which is obtained by fractionating and purifying oil collected from a fruit of an oil palm.

Among the above palm olein, palm olein of the edible fat and oil composition of the present invention is preferably selected from those having an iodine value of 64 or more, more preferably those having an iodine value of 64-80, further more preferably those having an iodine value of 65-72, and most preferably those having an iodine value of 66-72. When the iodine value thereof is 64 or more, it is possible to obtain an edible fat and oil composition making it possible to prepare cooked foods tasting and smelling good.

The iodine value can be easily measured in accordance with Standard Methods for the Analysis of Fats, Oils and Related Materials 2.3.4.1-1996 (Japan Oil Chemists' Society), for example.

In the present invention, palm olein can be used which comprises, as the constituent fatty acids, fatty acids having 18 carbon atoms and at least one unsaturated bond(s) at an amount of 58-68 mass %, more preferably 60-65 mass %, and most preferably 62-65 mass % in all constituent fatty acids of the palm olein. When the constituent fatty acids of palm olein are within the above range, it is possible to obtain an edible fat and oil composition making it possible to prepare cooked foods tasting and smelling better.

The above palm olein can be obtained by fractionating palm oil. More specifically, the clusters of oil palm are treated with steam and compressed to produce oil thereof. The produced oil is centrifuged to remove fibers and impurities and dried. Then, the oil is purified by degumming, deacidification, bleaching and deodorization. Examples of the refining method include chemical refining and physical refining, and either of them is usable.

The fractionation method of palm oil for obtaining palm olein is not particularly limited, and natural fractionation by cooling is usually used. It is also possible to use the fractionation method with a surfactant or a solvent. Palm olein is a medium-melting-point part or a low-melting-point part each of which is obtained by fractioning palm oil (a high-melting-point part is generally referred to as palm stearin). This fractionation can be conducted twice or three times, and it is possible to comprise a low-melting-point part obtained by fractionating several times in the edible fat and oil composition of the present invention, particularly those having an iodine value within the above range measured in accordance with the above method.

### Corn Oil

As corn oil used in the present invention, it is possible to use edible corn oil generally distributed.

Further, in the present invention, corn oil can be used which comprises, as the constituent fatty acids, fatty acids having 18 carbon atoms and at least one unsaturated bond(s) at an amount of 60-100 mass %, more preferably 70-95 mass %, and most preferably 75-90 mass % in all constituent fatty acids of the corn oil. When the constituent fatty acids of corn oil are within the above range, it is possible to obtain an edible fat and oil composition making it possible to prepare cooked foods tasting and smelling better.

### Other Components

In the edible fat and oil composition of the present invention, it is possible to comprise other oils and additives each of which are usually used in edible oils, without departing from the scope of the invention.

Examples of the above oils include generally-used edible oils such as safflower oil, grape seed oil, soybean oil, sunflower oil, rapeseed oil, cotton seed oil, sesame oil, Taihaku sesame oil, rice oil, peanut oil, olive oil, flaxseed oil, transesterified fats and oils, fats and oils having medium-chain fatty acids as constituent fatty acids, and fats and oils having medium-chain fatty acids and long-chain fatty acids as constituent fatty acids. Particularly, when comprising plenty of other oils, it is preferable to use safflower oil, sunflower oil, Taihaku sesame oil, fats and oils having medium-chain fatty acids as constituent fatty acids, or fats and oils having medium-chain fatty acids and long-chain fatty acids as constituent fatty acids.

Examples of the additives include antioxidants, nutrient enrichment agents, emulsifying agents, coloring components and antifoamers.

Examples of the antioxidants include tocopherols, tocotrienols, carotene, flavone derivatives, gallic acid derivatives, catechin and the esters thereof, sesamol and terpenes.

Examples of the nutrient enrichment agents include tocopherols, tocotrienols, phytosterols, esters of phytosetrols, γ-orizanol, astaxanthin, coenzyme Q10, carotene, capsaicin and capsiate.

In the present specification, examples of tocopherols include α-tocopherol, β-tocopherol, γ-tocopherol and α-tocopherol. Further, examples of tocotrienols include α-tocotrienol, β-tocotrienol, α-tocotrienol and δ-tocotrienol.

Examples of the emulsifying agents include polyglycerol esters of fatty acids, polyglycerol esters of polyricinoleic acid, sucrose esters of fatty acids, sorbitan esters of fatty acids, polysorbate, glycerol esters of mono-fatty acids, organic esters of glycerol esters of mono-fatty acids, propylene glycol esters of fatty acids and lecithin.

Examples of antifoamers include fine silica powder and silicone.

The edible fat and oil composition of the present invention more preferably comprises carotene among the other components. Examples of carotene include α-carotene and β-carotene. By comprising carotene therein, effects such as maintaining good eyesight during the night and maintaining the health of the skin and mucosa are expected.

The edible fat and oil composition more preferably comprises coenzyme Q10. By comprising coenzyme Q10 therein, higher effects of antioxidant action and antiaging action, etc. are expected to be imparted to the composition. Further, the edible fat and oil composition more preferably comprises tocotrienols. The odor or taste deterioration of the edible fat and oil composition can be suppressed by comprising tocotrienols, due to the antioxidant action thereof on fats and oils. In addition, the edible fat and oil composition can be expected to have the antioxidant action in vivo, the cholesterol-lowering effect and the arteriosclerosis ameliorating effect.

### Formulation of the Edible Fat and Oil Composition

The edible fat and oil composition of the present invention comprises the above palm olein and the corn oil and, optionally other components. Though the formulation amount of each component is not particularly limited, the following formulation amount is more preferable in order to accomplish the object of the present invention.

In the edible fat and oil composition of the present invention, the total amount of the palm olein and the corn oil is preferably 50-100 mass %, more preferably 70-100 mass %, and most preferably 90-100 mass %. When the formulation amount of the above two components in the whole edible fat and oil composition is 50 mass % or more, it is possible to obtain an edible fat and oil composition making it possible to prepare cooked foods tasting and smelling better.

Further, in the edible fat and oil composition of the present invention, the mass ratio of the palm olein and the corn oil is preferably 10:90-80:20, more preferably 20:80-80:20, further more preferably 25:75-75:25, and most preferably 30:70-70:30. When the mass ratio of the palm olein and the corn oil is 10:90-80:20, it is possible to obtain an edible fat and oil composition making it possible to prepare cooked foods tasting and smelling better.

When the edible fat and oil composition comprises carotene, the amount of carotene in the whole edible fat and oil composition is 1-600 ppm, preferably 1-400 ppm, and more preferably 5-300 ppm. The above effects of carotene can be more effectively obtained by comprising carotene within the above range.

When the edible fat and oil composition comprises coenzyme Q10, the amount of coenzyme Q10 in the whole edible fat and oil composition is preferably 0.1-200 ppm. The above effects of coenzyme Q10 can be more effectively obtained by comprising coenzyme Q10 within the above range.

When the edible fat and oil composition comprises tocotrienols, the amount of tocotrienols in the whole edible fat and oil composition is preferably 50-900 ppm. The above effects of tocotrienols can be more effectively obtained by comprising tocotrienols within the above range.

Meanwhile, as for each amount of the above carotene, coenzyme Q10 and tocotrienols, when these components are originally comprised in palm olein or canola oil each of which constitutes the edible fat and oil composition of the present invention, the amounts of the components originally comprised are also added in the calculation of the above numerical values. Therefore, the above numerical values are sometimes accomplished without newly adding the components. Besides, it is also possible to accomplish the above numerical values by adding the above carotene, coenzyme Q10 and tocotrienols as the additives.

### Method for Producing the Edible Fat and Oil Composition

The method for producing the edible fat and oil composition of the present invention is not particularly limited, and the composition is produced by stirring and mixing the palm olein and the corn oil, and, optionally the other components. The order of formulation of such components is not particularly limited. It is possible to heat the components in mixing if necessary.

### Product Forms of the Edible Fat and Oil Composition of the Present Invention

The edible fat and oil composition of the present invention can take any product form. The “product form” indicates a form in which the edible fat and oil composition is filled when transporting, preserving and selling the composition. Examples of product forms of the edible fat and oil composition of the present invention include a plastic bottle, a metallic can and pillow packaging. Since cooked foods tasting and smelling better can be prepared using the edible fat and oil composition of the present invention even after the composition is exposed to light, it is possible to fill it in a container at least part of which is formed of a light transmissive material. The “container at least part of which is formed of a light transmissive material” indicates a container a part of which has permeability that the content therein can be visually confirmed under the fluorescent light. Examples thereof include containers a part or all of which are formed of unpigmented PET, unpigmented lamicon, unpigmented glass, or the like.

Among these containers, the volume of the container is 2 L or less, and preferably 0.5-1.5 L. The edible fat and oil composition which is suitable for home use can be provided by filling the composition in such a container.

### Method for Producing a Cooked Food Using the Edible Fat and Oil Composition of the Present Invention

It is possible to produce a cooked food using the edible fat and oil composition of the present invention. Examples of a cooked food include grilled foods such as broiled meat and okonomiyaki (pancake with meat and vegetables); stir-fries such as fried noodles and stir-fried vegetables; and fries such as tempura, croquettes, fried fish and pork cutlet. In addition, the method for producing a cooked food of the present invention also includes the use of the edible fat and oil composition as demolding oil.

Specifically, the method comprises the steps of adding appropriate quantities of the edible fat and oil composition to an edible utensil and heating it, adding food materials thereto, and cooking them by grilling, stir-frying or deep frying. It is possible to change as appropriate an amount of the edible fat and oil composition, heating temperature and cooking time depending on a kind of used foods, food preparation method, or the like.

A Food which is Produced by Using the Edible Fat and Oil Composition of the Present Invention

Examples of the food produced by using the edible fat and oil composition of the present invention include seasoning agents, foods produced by the above method for producing the cooked foods such as grilled foods, stir-fries and fries, boiled foods and marinated foods.

Examples of the content of the edible fat and oil composition of the present invention in food are 10-80 mass % in a seasoning agent, 1-20 mass % in a grilled food, 1-20 mass % in a stir-fry, 1-40 mass % in a fry, 1-10 mass % in a boiled food, and 5-50 mass % in a marinated food.

Cooked foods tasting and smelling good can be prepared by using the edible fat and oil composition of the present invention, not only the composition exposed to light but also the composition not exposed to light.

The following Examples will further illustrate the present invention. They only explain the present invention and do not particularly limit the invention.

### EXAMPLES

“%” and “part” mentioned below indicate “mass %” and “part by weight” respectively unless specified otherwise. The iodine value is a value measured in accordance with the method of “Standard Methods for the Analysis of Fats, Oils and Related Materials 2.3.4.1-1996 (Japan Oil Chemists' Society)”.

Production of Fries Using the Edible Fat and Oil Composition of the Present Invention, and Evaluation of Odor and Taste of the Fries Produced with the Fat and Oil Composition Exposed to Light or not Exposed to Light

### (1) Oil Used, and Preparing the Fat and Oil Composition of the Present Invention

The following oils were used in the example:

Palm olein [iodine value 68] (produced by Intercontinental Specialty Fats SDN. BHD, a content of fatty acids having 18 carbon atoms and at least one unsaturated bond(s) in all constituent fatty acids: 63.1 mass %); and

Corn oil (trade name: Nisshin Corn Oil, produced by The Nisshin OilliO Group, Ltd., a content of fatty acids having 18 carbon atoms and at least one unsaturated bond(s) in all constituent fatty acids: 86.5 mass %).

The fat and oil composition of the present invention was prepared by using the above palm olein and the corn oil in the formulation ratio of Table 1 below. The preparation method complied with the method mentioned in the present specification.

### (2) Method for Producing Fries

As for each oil of Table 1 below, the oil not exposed to light and the oil exposed to light obtained by the process mentioned below were prepared, and fries were produced using the oil. Specifically, fries of horse mackerel were prepared using each of the oil not exposed to light and the oil exposed to light.

The fries of horse mackerel were produced by the method comprising the steps of heating each 1000 g of the oils up to 180° C., and frying frozen horse mackerel with bread crumbs therein for 4 minutes.

### (3) Condition of Light Exposure

1000 g of each fat and oil composition of Table 1 below was filled in an unpigmented PET container (for filling 1000 g of oil). Then, the unpigmented PET container in which the edible fat and oil composition was filled was exposed to light of 7000 Lux with a fluorescent lamp for 16 hours to obtain oil after being exposed to light.

### (4) Evaluation of the Produced Fries

The fries were evaluated by 10 panelists who ate the fries. They ate each sample and judged the odor and the taste thereof in accordance with the following evaluation standards.

### Odor

10-8: feeling no odor of fish
Less than 8-6: feeling faint odor of fish
Less than 6-4: feeling some odor of fish
Less than 4: feeling strong odor of fish

### Taste

⊚: feeling no odor of fish and tasty
◯: having a slight fishy aftertaste
Δ: having a fishy aftertaste
x: feeling a strong fishy odor in the mouth

### (5) Evaluation Results

TABLE 1

| | | | oil not | | oil | |
|---|---|---|---|---|---|---|
| | | | exposed | | exposed | |
| | | | to light | | to light | |
| | Sample | Mass ratio | Odor | Taste | Odor | Taste |
| Example 1 | Palm olein:corn oil | 60:40 | 8.6 | ⊚ | 8.0 | ⊚ |
| Example 2 | Palm olein:corn oil | 70:30 | 8.7 | ⊚ | 7.8 | ⊚ |
| Example 3 | Palm olein:corn oil | 80:20 | 8.2 | ⊚ | 7.5 | ⊚ |
| Comp. | Palm olein | 100 | 6.8 | ◯ | — | — |
| Example | | | | | | |
| Comp. | Corn oil | 100 | 5.8 | Δ | — | — |
| Example 2 | | | | | | |

As indicated in above Table 1, it is clarified that fries of horse mackerel produced using the edible fat and oil composition of the present invention smell and taste better than those produced using the oils of comparative examples. As for the edible fat and oil composition of the present invention, it was confirmed that the oil thereof exposed to light could maintain the odor and the taste of the fries as good as the oil thereof not exposed to light.

### Measurement of Amounts of Tocotrienols and Coenzyme Q10

Each amount of tocotrienols and coenzyme Q10 was measured in each of the edible fat and oil compositions which were formulated as indicated in Table 2 below. The measured amount of tocotrienols is a total amount of α-tocotrienol, β-tocotrienol, γ-tocotrienol and δ-tocotrienol.

The palm olein used is a prototype of The Nisshin OilliO Group, Ltd., which has an iodine value of 69 and comprises fatty acids having 18 carbon atoms and at least one unsaturated bond(s) at an amount of 63.4 mass % in all constituent fatty acids. The corn oil used is Nisshin Corn Oil (trade name) produced by The Nisshin OilliO Group, Ltd., comprising fatty acids having 18 carbon atoms and at least one unsaturated bond(s) at an amount of 86.5 mass % in all constituent fatty acids. Each amount of the tocotrienols and coenzyme Q10 in the fats and oils was measured with HPLC.

TABLE 2

| | | tocotrienols | coenzyme |
|---|---|---|---|
| | | (ppm) | Q10 (ppm) |
| Comp. Ex. 3 | Palm olein (iodine value 69) | 440 | 2.2 |
| Comp. Ex. 4 | Canola oil | 50 | 0 |
| Example 4 | Palm olein (i.v. 69):Corn | 300 | 1.3 |
| | oil = 60:40 | | |
| Example 5 | Palm olein (i.v. 69):Corn | 350 | 1.5 |
| | oil = 70:30 | | |
| Example 6 | Palm olein (i.v. 69):Corn | 400 | 1.8 |
| | oil = 80:20 | | |

1. An edible fat and oil composition comprising palm olein having an iodine value of 64 or more and corn oil.

2. The edible fat and oil composition according to claim 1, wherein the total amount of the palm olein and the corn oil in the whole edible fat and oil composition is 50-100 mass %.

3. The edible fat and oil composition according to claim 1, wherein the mass ratio of the palm olein and the corn oil is 10:90-80:20.

4. The edible fat and oil composition according to claim 1, wherein the iodine value of the palm olein is 64-80.

5. The edible fat and oil composition according to claim 1, wherein the composition is filled in a container at least a part of which is formed of a light transmissive material.

6. The edible fat and oil composition according to claim 5, wherein the volume of the container is 2 L or less.

7. An edible fat and oil composition which comprises palm olein having an iodine value of 64 or more and corn oil at the mass ratio of 10:90-80:20, wherein the total amount of the palm olein and the corn oil in the whole edible fat and oil composition is 50-100 mass %.

8. An edible fat and oil composition comprising palm olein and corn oil, wherein the composition is filled in a container of 2 L or less, at least a part of which is formed of a light transmissive material.

9. The edible fat and oil composition according to claim 1, further comprising carotene.

10. The edible fat and oil composition according to claim 1, further comprising coenzyme Q10.

11. The edible fat and oil composition according to claim 1, further comprising tocotrienols.

12. A method for producing a cooked food which comprises cooking food materials using the edible fat and oil composition according to claim 1.

13. A food produced by using the edible fat and oil composition according to claim 1.
